(19) United States
(12) Patent Application Publication
(10) Pub. No.: US 2018/0155463 A1
(43) Pub. Date: Jun. 7, 2018

(54) THIOCARBONYLTHIO-FREE RAFT POLYMERS AND THE PROCESS OF MAKING THE SAME

(71) Applicants: Henkel IP and Holding GmbH, Duesseldorf (DE); Henkel AG & Co. KGAA, Duesseldorf (DE)

(72) Inventors: Tianzhi Zhang, Skillman, NJ (US); Peter D. Palasz, Maidenhead Birkshire (GB)

(21) Appl. No.: 15/886,563

(22) Filed: Feb. 1, 2018

Related U.S. Application Data
(63) Continuation of application No. PCT/US2016/046285, filed on Aug. 10, 2016.
(60) Provisional application No. 62/203,166, filed on Aug. 10, 2015.

(51) Int. Cl. C08F 8/06; C08F 6/10; C08F 2/14; C08F 2/38; C08F 228/04; C08K 5/38

(52) U.S. Cl. CPC C08F 8/06; C08F 6/10; C08F 2/14; C08F 2438/03; C08F 228/04; C08K 5/38; C08F 2400/02; C08F 2/38

(57) ABSTRACT

A treatment process for removing the thiocarbonylthio group from the RAFT polymers without sacrificing the versatile complex architectures of polymer is disclosed. The resultant RAFT polymers have higher optical clarity and less odor than conventionally prepared RAFT polymers.

### FIELD OF THE INVENTION

The present invention relates to a method of making RAFT polymers with higher optical clarity and decreased odor. The RAFT polymers made with the inventive process removes the thiocarbonylthio group from the polymers, making them particularly well suited for designing complex polymer architectures.

### BACKGROUND OF THE INVENTION

Reversible Addition-Fragmentation chain Transfer, hereinafter referred to as RAFT, polymerization uses a thiocarbonylthio chain transfer agent to control molecular weight and polydispersity of the polymer during a free-radical polymerization. Since its discovery in 1998, intensive research has been conducted to synthesize complex architectures of macromolecules, including block, graft, comb, and star structures. The chain transfer agent can be varied to synthesize polymers having varied and high functionalities.

RAFT polymerization is believed to proceed under the control of a RAFT agent according to a mechanism which is simplistically illustrated below:

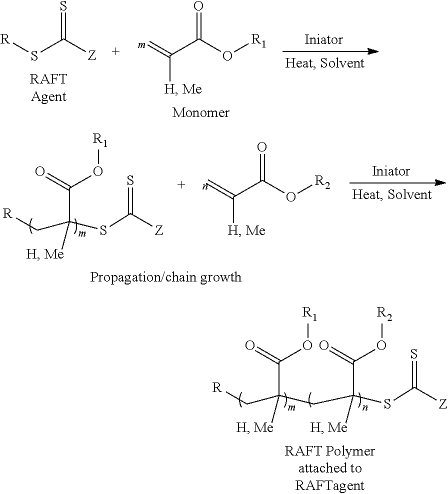

R represents a group that functions as a free radical leaving group under the polymerization conditions employed and yet, as a free radical leaving group, retains the ability to reinitiate polymerization. Z represents a group that functions to convey a suitable reactivity to the C═S moiety in the RAFT agent towards free radical addition without slowing the rate of fragmentation of the RAFT-adduct radical to the extent that polymerization is unduly retarded.

As shown above, polymers produced by RAFT polymerization, commonly referred to as RAFT polymers, inherently comprise a covalently bound residue of the RAFT agent. The RAFT agent residue itself comprises a thiocarbonylthio group (i.e. —C(S)S—) which may, for example, be in the form of a dithioester, dithiocarbamate, trithiocarbonate, or xanthate group.

While RAFT polymerization is possible in various solvents in wide temperature ranges and without compromising other functional group in polymer chain even in the absence of metal, there are several drawbacks. Only thiocarbonylthio-based chain transfer agents are suitable for a limited set of monomers. Moreover, the RAFT process requires subsequent purifications, and typically requires multiple purification steps since RAFT polymers are highly colored and have pungent odor due to gradual decomposition of the dithioester moiety of the chain transfer agent. The presence of this chain transfer agent in the end polymer is undesirable.

Batch wise treatment of RAFT polymers with various reagents such as nucleophiles, ionic reducing agents, oxidizing agents, or treatments such as irradiation has been shown to remove thiocarbonylthio groups from the RAFT polymer; however, such techniques are prone to relatively poor process control and reaction uniformity, leading to deficiencies in the resulting polymer quality. Thermolysis can also eliminate or cleave the thiocarboylthio group from the RAFT polymers; however, the functional groups that are covalently attached to the RAFT polymer may be negatively affected since thermolysis typically requires exposure to a temperature greater than 100° C.

U.S. Patent Publication 2014/0350182 discloses a method to continuously remove thiocarboylthio group from RAFT polymers by introducing the polymer into a flow reactor with a free radical initiator and a hydrogen atom donor. It further discloses that nucleophilic reagents and diene reagents be added to the flow reactor to induce thiocarbonylthio group removal, and to convert the end group to a thiol group. However, the flow reactor method of removal still leaves behind a sulfur group in the RAFT polymer, and ultimately the volatile sulfur containing compound is slowly released from the RAFT polymer, causing pungent odor. Moreover, flow reactors are prone to high pressure build-up if the liquid within the flow line becomes viscous. Therefore, care must be used to ensure the viscosity of the polymer solution remains low.

There is a need in the art for RAFT polymer and polymer treatment process that minimize color and odor without sacrificing the versatile complex architectures of macromolecules formed by the RAFT process. The current invention fulfills this need.

### BRIEF SUMMARY OF THE INVENTION

The invention provides a cleaner RAFT polymer and a treatment process for purifying RAFT polymers without burdensome purification steps that could compromise the functional groups on the RAFT polymers. According to the present invention, the thiocarbonylthio group is removed from RAFT polymers and the resultant RAFT polymers are optically clearer and have decreased odor.

One aspect of the invention is directed to a RAFT polymer prepared by a process comprising the steps of: (a) preparing a polymer by a RAFT polymerization with a thiocarbonylthio group as the chain transfer reagent in a solvent-based medium; (b) adding at least about 0.10% aqueous solution of H₂O₂, based on the polymer wt %, to the polymer in the solvent-based medium; and (c) exposing the polymer to a temperature of about 23 to about 120° C. The RAFT polymer produced in this manner has a lower color index and less odor than a RAFT polymer produced without step (b).

Another aspect of the invention is directed to a method for removing thiocarbonylthio end groups from a polymer prepared by RAFT polymerization in a solvent-based medium, comprising the steps of (a) adding at least about 0.10% aqueous solution of H₂O₂, based on the polymer wt %, to the polymer in the solvent-based medium; and (b) and exposing the polymer to a temperature of about 23 to about 120° C. In a further embodiment, the polymer is exposed to an increased temperature of about 40 to about 120° C. to accelerate removal of thiocarbonylthio group from RAFT polymer.

Yet another aspect of the invention is directed to a RAFT polymer prepared by a process comprising the steps of (a) preparing a monomer in a solvent-based medium; (b) adding a thiocarbonylthio group chain transfer agent to the monomer; (c) initiating the chain transfer agent to form the polymer; (d) terminating the reaction with the thiocarbonylthio group chain transfer agent as the end group; and (e) cleaving the end group by adding at least about 0.10% aqueous solution of H₂O₂, based on the polymer wt %, and exposing the polymer to a temperature of about 23 to about 120° C. The RAFT polymer has a lower color index and less odor than a RAFT polymer without step (e). In a further embodiment, the polymer at step (e) is exposed to an increased temperature of about 50 to about 120° C. to accelerate removal of thiocarbonylthio group from RAFT polymer.

These and other aspects of the invention are described in the detailed description below. In no event should the above summary be construed as a limitation on the claimed subject matter which is defined solely by the claimed as set forth herein.

### BRIEF DESCRIPTION OF THE DRAWINGS

The invention will also be described herein with reference to the following non-limiting drawings.

FIG. 1 shows a photograph of RAFT polymers before and after the removal of thiocarbonylthio group according to the invention.

FIG. 2 shows GPC curves of RAFT polymers before and after the removal of thiocarbonylthio group according to the invention.

### DETAILED DESCRIPTION OF THE INVENTION

All documents cited herein are incorporated in their entireties by reference.

Polymers prepared by RAFT polymerization can exhibit a well defined molecular architecture. As described in US Publication 2014/0350182, multiple RAFT polymerization reactions can be conducted sequentially so as to provide for well defined block copolymers. Those skilled in the art will appreciate that for the one or more ethylenically unsaturated monomers to undergo RAFT polymerization they must be of a type that can be polymerized by a free radical process. If desired, the monomers should also be capable of being polymerized with other monomers. The factors which determine copolymerizability of various monomers are well documented in the art. For example, see: Greenlee, R. Z., in Polymer Handbook 3^{rd} Edition (Brandup, J., and Immergut. E. H. Eds) Wiley: New York, 1989 p II/53.

Examples of monomers for RAFT polymerization include maleic anhydride, N-alkylmaleimide, N-arylmaleimide, dialkyl fumarate and cyclopolymerizable monomers, acrylate and methacrylate esters, acrylic and methacrylic acid, styrene, acrylamide, methacrylamide, and methacrylonitrile, mixtures of these monomers, and mixtures of these monomers with other monomers. These monomers can have other functionalities in the monomers and the functionalities will remain unreacted during the RAFT polymerization.

Other examples of monomers for RAFT polymerization include: methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, functional methacrylates, acrylates and styrenes selected from glycidyl methacrylate, benzophenone methacrylate, 3,4-epoxycyclohexylmethyl methacrylate, 3,4-epoxycyclohexylmethyl acrylate, 2-hydroxyethyl methacrylate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethylacrylamide, N-tert-butylmethacrylamide, N-n-butylmethacrylamide, N-methylolmethacrylamide, N-ethylolmethacrylamide, N-tert-butylacrylamide, N-n-butylacrylamide, N-methylolacrylamide, N-ethylolacrylamide, vinyl benzoic acid (all isomers), diethylamino styrene (all isomers), alpha-methylvinyl benzoic acid (all isomers), diethylamino alpha-methylstyrene (all isomers), p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropylacrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, ethylene and chloroprene. This list is not exhaustive.

RAFT agents suitable for preparing the RAFT polymer comprise a thiocarbonylthio group (which is a divalent moiety represented by: —C(S)S—). Examples of RAFT agents are described in Moad G.; Rizzardo, E; Thang S, H. Polymer 2008, 49, 1079-1131 (the entire contents of which are incorporated herein by reference) and include xanthate, dithioester, dithiocarbonate, dithiocarbamate and trithiocarbonate compounds, macro RAFT agents and switchable RAFT agents described in WO 10/83569. Three major classes of RAFT agents include dithiobenzoates, trithiocarbonates, dithiocarbamates, switchable RAFT agents, Macro-Raft agents, and RAFT Agent precursors.

Non-limiting examples of RAFT agents are listed in WO 98/01478 and WO 99/311444. Examples of trithiocarbonates include 3,5-bis(2-dodecylthiocarbonothioylthio-1-oxopropoxy)benzoic acid 98%, 3-butenyl 2-(dodecylthiocarbonothioylthio)-2-methylpropionate, 4-cyano-4-[(dodecylsulfanylthiocarbonyl)sulfanyl]pentanoic acid 97%, 4-cyano-4-[(dodecylsulfanylthiocarbonyl)sulfanyl]pentanol, cyanomethyl dodecyl trithiocarbonate 98%, cyanomethyl [3-(trimethoxysilyl)propyl] trithiocarbonate 95%, 2-cyano-2-propyl dodecyl trithiocarbonate 97%, S,S-dibenzyl trithiocarbonate, 2-(codecylthiocarbonothioylthio)-2-methylpropionic acid 98%, 2-(codecylthiocarbonothioylthio)-2-methylpropionic acid 3-azido-1-propanol ester 98%, 2-(Dcodecylthiocarbonothioylthio)-2-methylpropionic acid N-hydroxysuccinimide ester 98%, 2-(codecylthiocarbonothioylthio)-2-methylpropionic acid pentafluorophenyl ester, 2-(codecylthiocarbonothioylthio)propionic acid 97%, methyl 2-(dodecylthiocarbonothioylthio)-2-methylpropionate 97%, pentaerythritol tetrakis[2-(dodecylthiocarbonothioylthio)-2-methylpropionate] 97%, phthalimidomethyl butyl trithiocarbonate 97%, poly(acrylic acid), DDMAT terminated average Mn 10,000, PDI ≤1.1, poly(ethylene glycol) bis[2-(dodecylthiocarbonothioylthio)-2-methylpropionate] average Mn 10,800, poly(ethylene glycol) methyl ether 4-cyano-4-[(dodecylsulfanylthiocarbonyl)sulfanyl] pentanoate average Mn 10,000, poly(ethylene glycol) methyl ether (4-cyano-4-pentanoate dodecyl trithiocarbonate) average Mn 5,400, poly(ethylene glycol) methyl ether (4-cyano-4-pentanoate dodecyl trithiocarbonate) average, poly(ethylene glycol) methyl ether 2-(dodecylthiocarbonothioylthio)-2-methylpropionate, poly(ethylene glycol) methyl ether (2-methyl-2-propionic acid dodecyl trithiocarbonate), poly(L-lactide) 4-cyano-4-[(dodecylsulfanylthiocarbonyl)sulfanyl]pentonate, polystyrene, DDMAT terminated, and 1,1,1-Ttris[(dodecylthiocarbonothioylthio)-2-methylpropionate]ethane 98%. Examples of dithiocarbamates include benzyl 1H-pyrrole-1-carbodithioate 97%, cyanomethyl diphenylcarbamodithioate 97%, cyanomethyl methyl(phenyl)carbamodithioate 98%, cyanomethyl methyl(4-pyridyl)carbamodithioate 98%, 2-cyanopropan-2-yl N-methyl-N-(pyridin-4-yl)carbamodithioate 97%, methyl 2-[methyl(4-pyridinyl)carbamothioylthio]propionate 97%, and 1-succinimidyl-4-cyano-4-[N-methyl-N-(4-pyridyl)carbamothioylthio]pentanoate 98%. Examples of dithiobenzoates include benzyl benzodithioate 96%, cyanomethyl benzodithioate 98%, 4-cyano-4-(phenylcarbonothioylthio)pentanoic acid >97%, 4-cyano-4-(phenylcarbonothioylthio)pentanoic acid N-succinimidyl ester, 2-cyano-2-propyl benzodithioate >97%, 2-cyano-2-propyl 4-cyanobenzodithioate 98%, ethyl 2-(4-methoxyphenylcarbonothioylthio)acetate 99%, ethyl 2-methyl-2-(phenylthiocarbonylthio)propionate 95%, ethyl 2-(phenylcarbonothioylthio)-2-phenylacetate 98%, ethyl 2-(phenylcarbonothioylthio)propionate 97%, 1-(methoxycarbonyl)ethyl benzodithioate ≥97%, 2-(4-methoxyphenylcarbonothioylthio)ethanoic acid ≥97%, 2-nitro-5-(2-propynyloxy)benzyl 4-cyano-4-(phenylcarbonothioylthio)pentanoate 97%, and 2-(phenylcarbonothioylthio)propanoic acid 98%, 2-phenyl-2-propyl benzodithioate 99%. Examples of switchable RAFT Agents include cyanomethyl methyl(4-pyridyl)carbamodithioate 98%, 2-cyanopropan-2-yl N-methyl-N-(pyridin-4-yl)carbamodithioate 97%, methyl 2-[methyl(4-pyridinyl)carbamothioylthio]propionate 97%, and 1-Succinimidyl-4-cyano-4-[N-methyl-N-(4-pyridyl)carbamothioylthio]pentanoate 98%. Examples of macro-RAFT agents include poly(acrylic acid), DDMAT terminated average Mn 10,000, PDI ≤1.1, poly(tert-butyl acrylate), DDMAT terminated, azide terminated average Mn 8,500, PDI ≤1.2, poly(tert-butyl acrylate), DDMAT terminated average Mn 7,000, poly(N,N-dimethylacrylamide), DDMAT terminated average Mn 10,000, PDI ≤1.1, poly(ethylene glycol) bis[2-(dodecylthiocarbonothioylthio)-2-methylpropionate] average Mn 10,800, poly(ethylene glycol) 4-cyano-4-(phenylcarbonothioylthio)pentanoate average Mn 10,000, poly(ethylene glycol) 4-cyano-4-(phenylcarbonothioylthio)pentanoate average Mn 2,000, poly(ethylene glycol) methyl ether 4-cyano-4-[(dodecylsulfanylthiocarbonyl)sulfanyl] pentanoate average Mn 10,000, poly(ethylene glycol) methyl ether (4-cyano-4-pentanoate dodecyl trithiocarbonate) average greater than 1,300, poly(ethylene glycol) methyl ether 2-(dodecylthiocarbonothioylthio)-2-methylpropionate average Mn greater than 1,000, poly(ethylene glycol) methyl ether (2-methyl-2-propionic acid dodecyl trithiocarbonate) average Mn 10,000, poly(hydroxyethyl methacrylate), DDMAT terminated average Mn 7,000, PDI <1.2, Poly(D,L-lactide), 4-cyano-4-[(dodecylsulfanylthiocarbonyl)sulfanyl]pentonate terminated average Mn 20,000, PDI <1.4, polystyrene, DDMAT terminated average Mn greater than 4,000, PDI ≤1.1. Examples of RAFT Agent precursors include bis(dodecylsulfanylthiocarbonyl) disulfide 98%, nis(thiobenzoyl) disulfide>90%, and N,N′-dimethyl N,N′-di(4-pyridinyl)thiuram disulfide.

RAFT agent are also available from Boron Molecular under the BMI series. A non-limiting RAFT agents include 2-cyanobutan-2-yl dodecyl carbonotrithioate (BMI1442), 2-(((dodecylthio)carbonothioyl)thio)propanoic acid (BMI1430), 2-cyanobutan-2-yl 4-chloro-3,5-dimethyl-1H-pyrazole-1-carbodithioate (BM1565), 2-cyanobutan-2-yl methyl(piridin-4-yl)carbamodithioate (BM1458), 3-((((1-carboxyethyl)thio)carbonothioyl)thio)propanoic acid (BM1429), 4-cyano-4-(((dodecylthio)carbonothioyl)thio)pentanoic acid (BM1432), bis(dodecylsulfanyl thiocarbonyl)disulfide (BM1444), Bis(Methyl-pyridin-4-yl-amino-thiocarbonyl)disulfide (BM1478), cyanomethyl (3,5-Dimethyl-1H-pyrazole)-carbodithioate (BM1481), cyanomethyl methyl(phenyl)carbamodithioate (BM1434), dibenzyl trithiocarbonate (BM1361 and BM1039), methyl 2-(methyl(phenyl)carbamothioylthio)propanoate (BM1455), and methyl 4-cyano-4-(dodecylthiocarbonothioylthio)pentanoate (BM1448).

Particularly preferred RAFT agents include 2-Cyano-2-propyl benzodithioate, 2-Cyano-2-propyl dodecyl trithiocarbonate, and 4-Cyano-4-[(dodecylsulfanylthiocarbonyl)sulfanyl]pentanoic acid.

The degree of compatibility between the monomer classes and RAFT agent should be considered in selecting the appropriate agent for polymerization.

The RAFT polymers are formed in a non-aqueous-based solvent. Non-limiting examples include ethyl acetate, MEK, acetonitrile, ethanol, methanol, propanol, toluene, DMSO, and DMF.

In order for polymerization of monomer to proceed and produce RAFT polymer, free radicals must be generated within the flow reactor. A source of initiating radicals can be provided by any suitable means of generating free radicals, such as by the thermally induced homolytic scission of suitable compound(s) (thermal initiators such as peroxides, peroxyesters, or azo compounds), the spontaneous generation from monomers (e.g. styrene), redox initiating systems, photochemical initiating systems or high energy radiation such as electron beam, X- or gamma-radiation. The initiating system is chosen such that under the reaction conditions there is no substantial adverse interaction between the initiator or the initiating radicals and the components of the reaction solution under the conditions of the reaction. Where the initiating radicals are generated from monomer per se, it will be appreciated that the monomer may be considered to be the free radical initiator. In other words, provided that the required free radicals are generated the process is not limited to a situation where a dedicated or primary functional free radical initiator must be used. The initiator selected should also have the requisite solubility in the solvent.

Thermal initiators are generally chosen to have an appropriate half life at the temperature of polymerization. These initiators can include one or more of the following compounds: 2,2′-azobis(isobutyronitrile), 2,2′-azobis(2-cyanobutane), dimethyl 2,2′-azobis(isobutyrate), 4,4′-azobis(4-cyanovaleric acid), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N,N′-dimethyleneisobutyramidine)dihydrochloride, 2,2′-azobis(2-amidinopropane)dihydrochloride, 2,2′-azobis(N,N′-dimethyleneisobutyramidine), 2,2′-azobis{2-methyl-N-[1,1-bis(hydroxymethyl)-2-hydroxyethyl]propionamide}, 2,2′-azobis{2-methyl-N-[1,1-bis(hydroxymethyl)-2-ethyl]propionamide}, 2,2′-azobis[2-methyl-N-(2-hydroxyethyl)propionamide], 2,2′-azobis(isobutyramide)dihydrate, 2,2′-azobis(2,2,4-trimethylpentane), 2,2′-azobis(2-methylpropane), t-butyl peroxyacetate, t-butyl peroxybenzoate, t-butyl peroxyneodecanoate, t-butylperoxy isobutyrate, t-amyl peroxypivalate, t-butyl peroxypivalate, diisopropyl peroxydicarbonate, dicyclohexyl peroxydicarbonate, dicumyl peroxide, dibenzoyl peroxide, dilauroyl peroxide, potassium peroxydisulfate, ammonium peroxydisulfate, di-t-butyl hyponitrite, dicumyl hyponitrite. This list is not exhaustive.

Photochemical initiator systems are generally chosen to have an appropriate quantum yield for radical production under the conditions of the polymerization. Examples include benzoin derivatives, benzophenone, acyl phosphine oxides, and photo-redox systems.

Redox initiator systems are generally chosen to have an appropriate rate of radical production under the conditions of the polymerization; these initiating systems can include, but are not limited to, combinations of the following oxidants (potassium, peroxydisulfate, hydrogen peroxide, t-butyl hydroperoxide) and reductants (iron (II), titanium (III), potassium thiosulfite, potassium bisulfate).

Other suitable initiating systems are described in commonly available texts. See, for example, Moad and Solomon “The Chemistry of Free Radical Polymerization,” Pergamon, London, 1995, pp 53-95.

Initiators that are more readily solvated in hydrophilic media include, but are not limited to, 4,4-azobis(cyanovaleric acid), 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N,N′-dimethyleneisobutyramidine), 2,2′-azobis(N,N′-dimethyleneisobutyramidine)dihydrochloride, 2,2′-azobis(2-amidinopropane)dihydrochloride, 2,2′-azobis{2-methyl-N-[1,1-bis(hydroxymethyl)-2-ethyl]propionamide}, 2,2′-azobis[2-methyl-N-(2-hydroxyethyl)propionamide], 2,2′-azobis(isobutyramide)dihydrate, and derivatives thereof.

Initiators that are more readily solvated in hydrophobic media include azo compounds, such as 2,2′-azobisisobutyronitrile. Other suitable initiator compounds include the acyl peroxide class such as acetyl and benzoyl peroxide as well as alkyl peroxides such as cumyl and t-butyl peroxides. Hydroperoxides such as t-butyl and cumyl hydroperoxides are also widely used.

A wide range of polymer structure can be designed using the RAFT polymerization, ranging from linear monoblock including end-functional, di-end functional, telechelic graft copolymer, AB diblock, ABA triblock, 8-arm star, 8-arm di-block star, brush, comb, and microgel architectures.

The resultant RAFT polymers always includes at least one RAFT agent in each RAFT polymer chain, resulting in highly colored solution that has a pungent odor. The dithioester moiety of the RAFT agent left in the polymer chain, will gradually decompose further, exacerbating the color and odor problems.

The thiocarbonylthio groups can be removed from the RAFT polymer by adding aqueous solution of H₂O₂ to the RAFT polymer in the solvent-based medium. An amount of at least about 0.1 wt % of H2O2, based on the weight of the polymer, is required to remove thiocarbonylthio groups from the RAFT polymer. Preferably, the aqueous H₂O₂ is added at least about 0.1 wt % or greater, preferably at least about 0.2 wt %, 0.3 wt %, 0.4 wt %, 0.5 wt %, 0.6 wt %, 0.7 wt %, 0.8 wt %, 0.9 wt %, 1.0 wt %, based on the weight of the RAFT polymer. While large concentrations of H₂O₂ may be added to remove the RAFT agent from the RAFT polymer, such large concentrations can later negatively affect the polymer properties, and therefore, minimizing the quantities of H₂O₂ to less than about 20 wt %, preferably less than about 15 wt %, and most preferably less than about 10 wt %, is desirable. All numerical weight percent range that falls in between 0.1 wt % to 20 wt % is considered to be within the preferred ranges of the aqueous H₂O₂ for removing thiocarbonylthio agents from the RAFT polymers.

In one embodiment, the aqueous solution of H₂O₂ is added to the RAFT polymer, and left at room temperature for at least one hour. In another embodiment, polymer is exposed to an elevated temperature higher than room temperature to about 120° C. after the addition of aqueous solution of H₂O₂. All temperature range that falls in between room temperature to about 120° C. is considered to be within the preferred temperature ranges. The RAFT polymers can be exposed at the desired temperatures ranging from 1 to 24 hours, and all time ranges in between those numbers are also contemplated. Depending on the RAFT polymer, a skilled artisan can vary the amount H₂O₂, exposure time and temperature to speed up the treatment and to optimize the resultant polymer. The color and odor of the RAFT polymer decreases after exposure to aqueous solution of H₂O₂. The color, measured in accordance with ASTM D1209 (APHA index), of the treated RAFT polymer with H₂O₂ decreases by at least two-folds, and even by at least by three-folds, than the untreated RAFT polymers. Also, odor of the treated RAFT polymers was significantly improved over the untreated RAFT polymers. Moreover, functional group in the RAFT polymer chains are not affected by the addition of the H₂O₂, and remains intact.

Surprisingly, the addition of the aqueous solution of H₂O₂ into solvent-based RAFT polymers were miscible and did not result in a phase separation. Also, the thiol dithioester moiety cleaved from the RAFT, eliminating many drawbacks associated with RAFT polymers. Without being bound to any particular theory, the addition of H₂O₂ removes thiocarbonylthio group from the RAFT polymers and the resultant RAFT polymers are end-capped with secondary hydroxyl groups. Further treatment with heat further decomposes the secondary hydroxyl groups to unsaturated carbon-carbon bonds in the RAFT polymers without negatively affecting other functional groups on the polymer.

The thiocarbonylthio-free RAFT polymers made from the above process may be used as additives as performance enhancers or reactive additive, or as base polymers in sealants, coatings and adhesives. In one embodiment, the thiocarbonylthio-free RAFT polymers may be formed as a pressure sensitive adhesive or pressure sensitive hot melt adhesive.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

### EXAMPLES

### Macro-RAFT Pre-Polymer (Pre-Polymer1) Synthesis

2-Cyanobutan-2-yl dodecyl carbonotrithioate (Boron Molecular BM1442) (20.23 g), methyl methacrylate (180.03 g), glycidyl methacrylate (20.1 g) and ethyl acetate (140.77 g) were added in a flak. The flask was then connected with a mechanical stirrer, a condenser, a nitrogen gas bubbler and placed into a 73.5° C. oil bath. Under the nitrogen protection, Vazo 68 (3.84 g) in ethyl acetate (6.04 g) was injected into the reaction mixture at above 60° C. The mixture was stirred for about 10 hours and then cooled to room temperature and quenched in the presence of air.

### Example 1

### Sample 1 Di-Block Copolymer Synthesis

Monomer Solution A was formed by mixing methyl acrylate (89.78 g), acrylic acid (18.44 g), and ethylhexyl acrylate (176.52 g) until homogeneous.

Initiator Solution B was made by mixing Vazo 68 (0.1143 g) and ethyl acetate (80.39 g) until homogeneous.

Pre-polymer 1 (39.71 g) and ethyl acetate (152.81 g) were added to a 1 L flask. The flask was connected with a mechanical stirrer, a condenser, a nitrogen gas bubbler, Monomer Solution A, and Initiator Solution B feeder. The reaction mixture was then set to reflux under a nitrogen blanket. At reflux, Monomer Solution A and Initiator Solution B were slowly added to the flask over a period of 4 hours. The reaction mixture was allowed to react for two additional hours. Quenching agent, tert-Amyl peroxypivalate (1.71 g), was then added and the reaction mixture was stirred at reflux for additional two hours. The reaction mixture was then cooled down to room temperature. The measured APHA color index of Sample 1 was 271 (light yellow).

Analysis: GPC: Mw 167005, PDI 4.3, PMMA standard.

### Example 2

### Treatment Conditions for Diblock Sample 1

The diblock Sample 1 was treated with varying amounts of H₂O₂ (50% aq) and conditions (temperature and time) to find an optimal treatment condition.

TABLE 1

| | % H2O2 | | Exposure | | |
|---|---|---|---|---|---|
| | based on | T | time | | |
| | polymer | (° C.) | (hours) | Color* | APHA |
| 1 | 0 | 23 | none | Bright yellow | 271 |
| 1A | 16.50 | 23 | 8 | Bright yellow | |
| 1B | 16.50 | 55 | 8 | Water-white | |
| 1C | 4.97 | 65 | 3 | Water-white | |
| 1D | 2.43 | 65 | 3.5 | Faint yellow | |
| 1E | 1.08 | 60 | 3.5 | Faint yellow | |
| 1F | 0.06 | 60 | 4 | Water-white | |
| 1G | 0.24 | 60 | 4.5 | Water-white | 58 |

*Bright yellow was observed to have the most color, followed by faint yellow, and then water-white.

It was found that H₂O₂, even at very low concentration, can cleave the thiocarbonylthio groups from the RAFT polymers. Elevated temperature and exposure time to that temperature can accelerate the cleaving process.

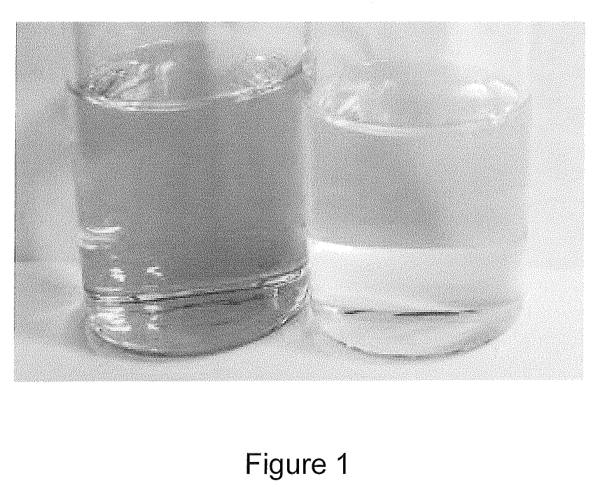

A side-by-side photograph of the untreated diblock Sample 1 (left) and treated sample G (right) is shown in FIG. 1. The treatment has significantly improved the color of the diblock sample.

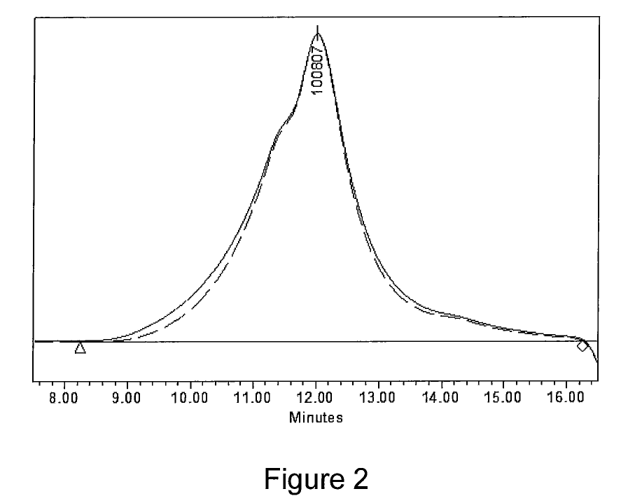

Also, an overlay of the GPC of the untreated diblock Sample 1 (dash line) and treated sample G (solid line) is shown in FIG. 2. Both GPC curves were substantially the same (with the same peak, shape and profile), and the addition of H₂O₂ did not change the acrylic groups in the polymer.

### Example 3

### Sample 2 Di-Block Copolymer Synthesis

### Di-Block Synthesis

Pre-polymer 1 (43.29 g), ethyl acetate (193.62 g), methyl acrylate (97.80 g), acrylic acid (20.19 g), and ethylhexyl acrylate (192.2 g) were added to a 1 L flask. The flask was connected with a mechanical stirrer, condenser, a nitrogen gas bubbler and Initiator Solution C feeder. Initiator Solution C was made by mixing Vazo 68 (0.0860 g) and ethyl acetate (60 g) until homogeneous. The reaction mixture was then set to reflux under nitrogen blanket. At reflux, Initiator Solution C was slowly added to the mixture over a period of 4 hours. The reaction mixture was allowed to react for 2 additional hours. Quenching agent, tert Amyl peroxypivalate (1.86 g), was then added and the reaction mixture was stirred at reflux for two additional hours. The reaction mixture was cooled to room temperature.

Analysis: GPC: Mw 116755, PDI 3.5, PMMA standard.

### Example 4

### Treatment Conditions for Diblock Sample 2

The diblock Sample 1 was treated with various amounts of H₂O₂ and conditions (temperature and time) to find an optimal treatment condition.

TABLE 2

| | % H2O2 | | Exposure | | Odor** |
|---|---|---|---|---|---|
| | based on | T | time | | (10 minutes |
| | polymer | (° C.) | (hours) | Color* | at 120° C.) |
| 2 | 0 | 23 | 0 | Bright yellow | Pungent sulfur odor |
| 2H | 0.29 | 90 | 3.7 | Faint yellow | Faint sulfur smell |
| 2I | 0.60 | 90 | 3.7 | Water-white | Trace of sulfur |
| | | | | | smell |
| 2J | 0.90 | 90 | 2 | Water-white | No trace of any |
| | | | | | sulfur smell |
| 2K | 1.19 | 90 | 2 | Water-white | No trace of any |
| | | | | | sulfur smell |
| 2L | 1.48 | 90 | 1 | Water-white | No trace of any |
| | | | | | sulfur smell |
| 2M | 1.80 | 90 | 1 | Water-white | No trace of any |
| | | | | | sulfur smell |

*Bright yellow was observed to have the most color, followed by faint yellow, and then water-white.
**Pungent sulfur was deemed to have the strongest smell, followed by fain, then trace and no trace.

As the amount of the peroxide is increased in the diblock Sample 2, the color and odor improved.

### Example 5

### Sample 3 Di-Block Copolymer Synthesis

### Macro-RAFT Pre-Polymer 2 (Synthesis)

4-Cyano-4-(((dodecylthio)carbonothioyl)thio)pentanoic acid (Boron Molecular BM1432) (2.20 g), methyl methacrylate (42.02 g), glycidyl methacrylate (20.1 g) and ethyl acetate (62.00 g) were added in a flask. The flask was then connected with a mechanical stirrer, a condenser, a nitrogen gas bubbler and placed into a 73.5° C. oil bath. Under the nitrogen protection, Vazo 68 (0.47 g) in ethyl acetate (4.47 g) was injected into the reaction mixture at above 60° C. The mixture was stirred for about 8 hours and then cooled to room temperature and quenched in the presence of air.

Analysis: GPC: Mw 9977, PDI 1.17, PMMA standard.

Monomer Solution A was formed by mixing methyl acrylate (121.38 g ethylhexyl acrylate (121.19 g), and ethyl acetate (226.94 g) until homogeneous.

Initiator Solution B was made by mixing Vazo 68 (0.0876 g) and ethyl acetate (80.26 g) until homogeneous.

Pre-polymer 2 solution (50.90 g) and ethyl acetate (56.43 g) were added to a 1 L flask. The flask was connected with a mechanical stirrer, a condenser, a nitrogen gas bubbler, Monomer Solution A, and Initiator Solution B feeder. The reaction mixture was then set to reflux under a nitrogen blanket. At reflux, Monomer Solution A and Initiator Solution B were slowly added to the flask over a period of 4 hours. The reaction mixture was allowed to react for two additional hours. Quenching agent, tert-Amyl peroxypivalate (1.61 g), was then added and the reaction mixture was stirred at reflux for additional two hours. The reaction mixture was then cooled down to room temperature.

Analysis: GPC: Mw 140121, PDI 14.7, PMMA standard; Polymer content: 47.5 wt %.

### Removal of Thiocarbonylthio Chain Transfer Agent

Hydrogen peroxide, 50% aq., (0.40 g) was added to the above di-block solution (87.41 g). The solution was heated in 90° C. bath for two hours. A color change was observed from yellow to water white and the odor significantly diminished and no the solution no longer had any sulfur smell.

### Color Determination in Accordance With APHA Scale (ASTM D1209)

Sample 3 and H₂O₂ treated Sample 3 were tested in accordance with ASTM D1209. The color was measured using the APHA scale and reported in Table 3.

TABLE 3

| | Color ALPHA Scale | Color observation |
|---|---|---|
| Sample 3 | 313 | Bright yellow |
| Sample 3 treated | 56 | Water white |
| with H₂O₂ | | |

The treated sample had far lower ALPHA Scale color than the untreated Sample 3.

### Example 6

### Sample 4: One Pot UV Curable Tri-Block Copolymer Synthesis

### MMA Block (Block A) Synthesis

RAFT agent—2-Cyanobutan-2-yl dodecyl carbonotrithioate (Boron Molecular BM1442) (0.94 g), methyl methacrylate (12.02 g), and ethyl acetate (9.26 g) were added to a flask. The flask was connected with a mechanical stirrer, a condenser, a nitrogen gas bubbler, and placed into a 73.5° C. oil bath. Under the nitrogen protection, Vazo 68 (0.22 g) in ethyl acetate (3.68 g) was injected into the reaction mixture at about 60° C. The mixture was stirred for about 6 hours.

Analysis: GPC: Mw 5735, PDI 1.4, PMMA standard.

### Block Extension (Block A-Block B) Synthesis

Visiomer 6976 (8.00 g) in ethyl acetate (8.01 g) was added to the above reaction mixture, and stirred for additional ten hours at 73.5° C.

Analysis: GPC: Mw 10129, PDI 1.3, PMMA standard.

### MA-co-EHA Block Extension (Block A-Block B-Block C) Synthesis

Monomer Solution F was made by adding and mixing methyl acrylate (124.24 g), ethylhexyl acrylate (2-EHA) (123.33 g) and ethyl acetate (166.2 g) in a bottle until homogeneous.

Initiator Solution G was made by adding and mixing Vazo 68 (0.0929 g) and ethyl acetate (82.08 g) in a separate bottle until homogeneous.

Additional ethyl acetate (121.65) was added to the flask containing Visionmer mixture. The flask was then connected with Monomer Solution F and Initiator Solution H feeder. The reaction was then set to reflux under a nitrogen blanket.

At reflux, Monomer Solution F and Initiator Solution G were slowly added in the above mixture over four hours. The reaction mixture was allowed to react for two additional hours. Quenching agent, tert-Amyl peroxypivalate (1.60 g), was added, and the reaction mixture was stirred at reflux for additional two hours. The reaction mixture was then cooled to room temperature.

Analysis: GPC: Mw 143189, PDI 5.9, PMMA standard.

### Removal of Thiocarbonylthio Chain Transfer Agent

Hydrogen peroxide, 50% aq., (0.82 g) was added to the above tri-block solution (198.07 g, 41.7 wt %). The solution was heated in 90° C. bath for two hours Analysis: GPC: Mw 126899, PDI 7.3, PMMA standard.

### Color Determination in Accordance With APHA Scale (ASTM D1209)

Sample 4 and H₂O₂ treated Sample 4 were tested in accordance with ASTM D1209. The color was measured using the APHA scale and reported in Table 4.

TABLE 4

| | Color ALPHA Scale | Color observation |
|---|---|---|
| Sample 4 | 294 | Bright yellow |
| Sample 4 treated | 72 | Water white |
| with H₂O₂ | | |

The treated sample had far lower APHA Scale color than the untreated Sample 4.

### Example 7

### Pressure Sensitive Adhesive

Sample 4 treated with H₂O₂, UV-curable tri-block copolymer, was UV cured and tested for SAFT, Shear and peel properties.

TABLE 5

| | Sample 4 treated | Sample 4 treated |
|---|---|---|
| | with H₂O₂ | with H₂O₂ |
| Cure dose (mJ UVC) | 100 | 120 |
| SAFT 1 kg (° C.) | 105 | 130 |
| Shear (1 kg 70° C.) | >170 hr | — |
| Peel (N/25 mm) 20 minutes | 8.1 | — |
| Peel (N/25 mm) 24 hours | 12.1 | — |

1N/25 mm = 3.6 oz/in

As demonstrated in Table 5, the cured RAFT polymer had acceptable SAFT, Shear and Peel values for use as a pressure sensitive adhesive.

1: A RAFT polymer prepared by a process comprising the steps of:
a) preparing a polymer by a RAFT polymerization with a thiocarbonylthio group as the chain transfer reagent in a solvent-based medium;
b) adding at least 0.10% aqueous solution of H₂O₂, based on the polymer wt %, to the polymer in the solvent-based medium; and
c) exposing the polymer to a temperature of about 23 to about 120° C.;
wherein the RAFT polymer has a lower color index and less odor than a RAFT polymer prepared without step (b).

2: The RAFT polymer of claim 1, wherein the thiocarbonylthio group is selected from a group consisting of 2-cyano-2-propyl benzodithioate, 2-cyano-2-propyl dodecyl trithiocarbonate, 4-cyano-4-[(dodecylsulfanylthiocarbonyl)sulfanyl]pentanoic acid, 4-cyano-4-(((dodecylthio)carbonothioyl)thio)pentanoic acid, 2-cyanobutan-2-yl dodecyl carbonotrithioate, 2-(((dodecylthio)carbonothioyl)thio)propanoic acid, 2-cyanobutan-2-yl 4-chloro-3,5-dimethyl-1H-pyrazole-1-carbodithioate, 2-cyanobutan-2-yl methyl(piridin-4-yl)carbamodithioate, 3-((((1-carboxyethyl)thio)carbonothioyl)thio)propanoic acid, 4bis(dodecylsulfanyl thiocarbonyl)disulfide, Bis(Methyl-pyridin-4-yl-amino-thiocarbonyl)disulfide, cyanomethyl (3,5-Dimethyl-1H-pyrazole)-carbodithioate, cyanomethyl methyl(phenyl)carbamodithioate, Dibenzyl trithiocarbonate, methyl 2-(methyl(phenyl)carbamothioylthio)propanoate, methyl 4-cyano-4-(dodecylthiocarbonothioylthio)pentanoate, and mixtures thereof.

3: The RAFT polymer of claim 2, wherein the thiocarbonylthio group is selected from a group consisting of 2-cyano-2-propyl benzodithioate, 2-cyano-2-propyl dodecyl trithiocarbonate, 4-cyano-4-[(dodecylsulfanylthiocarbonyl)sulfanyl]pentanoic acid, 4-cyano-4-(((dodecylthio)carbonothioyl)thio)pentanoic acid, 2-cyanobutan-2-yl dodecyl carbonotrithioate, and mixtures thereof.

4: The RAFT polymer of claim 1, wherein the solvent-based medium is selected from the group consisting of ethyl acetate, MEK, ethanol, methanol, propanol, toluene, DMSO, DMF, and mixtures thereof.

5: The RAFT polymer of claim 1, wherein the polymer is exposed to a temperature of about 40 to about 120° C. in step (c).

6: The RAFT polymer of claim 5, wherein the polymer is exposed to a temperature of about 50 to about 100° C. in step (c).

7: The RAFT polymer of claim 1, wherein the color, measured in accordance with ASTM D1209, of the end-capped RAFT polymer is at least 50% less than the RAFT polymer prepared without step (b).

8: A method for removing a plurality of thiocarbonylthio groups from a polymer prepared by RAFT polymerization in a solvent-based medium comprising the steps of:
a) adding at least about 0.1 wt % aqueous solution of H₂O₂, based on the weight of the polymer, to the polymer in the solvent-based medium; and
b) exposing the polymer to a temperature of about 23 to about 120° C.

9: The method of claim 8, wherein the solvent-based medium is selected from the group consisting of ethyl acetate, MEK, ethanol, acetonitrile, methanol, propanol, toluene, DMSO, DMF, and mixtures thereof.

10: The method of claim 8, wherein the polymer is exposed to a temperature of about 40 to about 120° C. in step (b).

11: The method of claim 10, wherein the polymer is exposed to a temperature of about 50 to about 100° C. in step (b).

12: The method of claim 8, wherein the color, measured in accordance with ASTM D102, of the end-capped RAFT polymer is at least 50% less than the RAFT polymer without step (b).

13: A RAFT polymer prepared by a process comprising the steps of:
a) preparing a monomer in a solvent-based medium;
b) adding a thiocarbonylthio group chain transfer agent to the monomer;
c) initiating the chain transfer agent to form the polymer;
d) terminating the reaction with the thiocarbonylthio group chain transfer agent as the end group; and
e) cleaving the end group by adding at least 0.1 wt % aqueous solution of H₂O₂, based on the polymer weight, and exposing the polymer to about 23 to about 120° C.;
wherein the RAFT polymer has a lower color index and less odor than a RAFT polymer prepared without step (e).

14: The RAFT polymer of claim 13, wherein the thiocarbonylthio group is selected from a group consisting of 2-cyano-2-propyl benzodithioate, 2-cyano-2-propyl dodecyl trithiocarbonate, 4-cyano-4-[(dodecylsulfanylthiocarbonyl)sulfanyl]pentanoic acid, 4-cyano-4-(((dodecylthio)carbonothioyl)thio)pentanoic acid, 2-cyanobutan-2-yl dodecyl carbonotrithioate, 2-(((dodecylthio)carbonothioyl)thio)propanoic acid, 2-cyanobutan-2-yl 4-chloro-3,5-dimethyl-1H-pyrazole-1-carbodithioate, 2-cyanobutan-2-yl methyl(piridin-4-yl)carbamodithioate, 3-((((1-carboxyethyl)thio)carbonothioyl)thio)propanoic acid, 4bis(dodecylsulfanyl thiocarbonyl)disulfide, Bis(Methyl-pyridin-4-yl-amino-thiocarbonyl)disulfide, cyanomethyl (3,5-Dimethyl-1H-pyrazole)-carbodithioate, cyanomethyl methyl(phenyl)carbamodithioate, Dibenzyl trithiocarbonate, methyl 2-(methyl(phenyl)carbamothioylthio)propanoate, methyl 4-cyano-4-(dodecylthiocarbonothioylthio)pentanoate, and mixtures thereof.

15: The RAFT polymer of claim 14, wherein the thiocarbonylthio group is selected from a group consisting of 2-cyano-2-propyl benzodithioate, 2-cyano-2-propyl dodecyl trithiocarbonate, 4-cyano-4-[(dodecylsulfanylthiocarbonyl)sulfanyl]pentanoic acid, 4-cyano-4-(((dodecylthio)carbonothioyl)thio)pentanoic acid, 2-cyanobutan-2-yl dodecyl carbonotrithioate, and mixtures thereof.

16: The RAFT polymer of claim 13, wherein the solvent-based medium is selected from the group consisting of ethyl acetate, MEK, ethanol, acetonitrile, methanol, propanol, toluene, DMSO, DMF, and mixtures thereof.

17: The RAFT polymer of claim 13, wherein the polymer is exposed to a temperature of about 50 to about 100° C. in step (e).

18: The RAFT polymer of claim 13, wherein the color, measured in accordance with ASTM D1209, of the end-capped RAFT polymer is at least 50% less than the RAFT polymer prepared without step (e).
